(19) United States
(12) Patent Application Publication
(10) Pub. No.: US 2026/0062577 A1
(43) Pub. Date: Mar. 5, 2026

(54) Ink Jet Ink Composition And Recording Method

(71) Applicant: SEIKO EPSON CORPORATION, Tokyo (JP)

(72) Inventors: Tetsuya AOYAMA, Shiojiri (JP); Kenta KIKUCHI, Suwa (JP); Tetsuya ITO, Matsumoto (JP)

(21) Appl. No.: 19/316,325

(22) Filed: Sep. 2, 2025

(30) Foreign Application Priority Data
Sep. 3, 2024 (JP) 2024-151402

(51) Int. Cl. C09D 11/326; C09D 11/322; C09D 11/38; C09D 11/40

(52) U.S. Cl. CPC C09D 11/326; C09D 11/322; C09D 11/38; C09D 11/40

(57) ABSTRACT

Provided is an ink jet ink composition containing a pigment, a resin binder, and an organic solvent. The pigment includes a resin-dispersed pigment dispersed with a crosslinked resin. The resin binder includes a self-emulsifying type resin binder. The organic solvent includes an organic solvent having an octanol-water partition coefficient log P_{ow} value of 0 to 1.

The present application is based on, and claims priority from JP Application Serial Number 2024-151402, filed Sep. 3, 2024, the disclosure of which is hereby incorporated by reference herein in its entirety.

### BACKGROUND

### 1. Technical Field

The present disclosure relates to an ink jet ink composition and a recording method.

### 2. Related Art

Ink jet recording methods can record high-resolution images with a relatively simple apparatus and are rapidly developed in various fields. For example, JP-A-2018-109119 discloses an ink composition containing a pigment, an organic compound, and water and having a resolubility index of 0.5 minute or more and 10 minutes or less, which is the time, when the mass is reduced to 50% to be thickened, required for the ink composition to return to the ink viscosity before thickening by adding the same amount of water as the reduced mass, for the purpose of providing an ink composition excellent in continuous printing stability with reduced occurrence of gas-liquid interface foreign substances and can produce a printed matter excellent in image fastness.

As described in JP-A-2018-109119, from the viewpoint of improving image fastness such as line marker resistance, resin particles may be added to the ink composition. However, on the other hand, the addition of resin particles easily causes clogging of an ink jet head.

### SUMMARY

An ink jet ink composition of the present disclosure is an ink jet ink composition containing a pigment, a resin binder, and an organic solvent. The pigment includes a resin-dispersed pigment dispersed with a crosslinked resin. The resin binder includes a self-emulsifying type resin binder. The organic solvent includes an organic solvent having an octanol-water partition coefficient log P_{ow} value of 0 to 1. The ink jet ink composition is an aqueous ink.

A recording method of the present disclosure attaches an ink containing the ink jet ink composition to a recording medium.

### BRIEF DESCRIPTION OF THE DRAWINGS

FIG. 1 is Table 1 showing the compositions of respective compositions used in Examples and the evaluation results thereof.

FIG. 2 is Table 2 showing the compositions of respective compositions used in Examples and the evaluation results thereof.

FIG. 3 is Table 3 showing the compositions of respective compositions used in Comparative Examples and the evaluation results thereof.

FIG. 4 is a diagram showing an example of a recording apparatus used in a recording method according to the present embodiment.

### DESCRIPTION OF EMBODIMENTS

The present embodiment will be described below in detail with reference to the drawings as needed, but the present disclosure is not limited thereto, and various modifications can be made without departing from the gist thereof. Note that in the drawings, the same elements are denoted by the same reference signs, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Ink Jet Ink Composition

The ink jet ink composition according to the present embodiment contains a pigment, a resin binder, and an organic solvent. The pigment includes a resin-dispersed pigment dispersed with a crosslinked resin. The resin binder includes a self-emulsifying type resin binder. The organic solvent includes an organic solvent having an octanol-water partition coefficient log P_{ow} value (hereinafter also referred to as “log P_{ow} value”) of 0 to 1.

When the abrasion resistance of a recorded matter is low, peeling of an ink is likely to occur when the recorded matter is rubbed, and bleeding is likely to occur when a recording surface is traced with a line marker. To improve this, resin particles may be used, but there is a problem in that the addition of resin particles easily causes clogging of an ink jet head.

Given this, in the present embodiment, a resin-dispersed pigment dispersed with a crosslinked resin, a self-emulsifying type resin binder, and an organic solvent having a predetermined log P_{ow} value are used in combination.

The self-emulsifying type resin binder is excellent in redispersibility and clogging recoverability while improving abrasion resistance, but to disperse such a self-emulsifying type resin binder in water, it is necessary to use an organic solvent having a high log P_{ow} value (hereinafter also referred to as “high log P_{ow} solvent”) in combination. However, since the high log P_{ow} solvent dissolves a dispersant resin in which a pigment is dispersed, the dispersion stability of the pigment decreases, which can cause problems such as deterioration of storage stability and clogging recoverability. Given this, a resin-dispersed pigment in which a pigment is dispersed with a crosslinked resin is used as the pigment. Such a resin-dispersed pigment resists being peeled off from the pigment and resists being dissolved in the high log P_{ow} solvent because the dispersant resin in which the pigment is dispersed is crosslinked. This enables the combined use of the self-emulsifying type resin binder and the high log P_{ow} solvent.

Components that can be contained in the ink composition according to the present embodiment and a production method thereof will be described below in detail.

### 1.1. Pigment

In general, the pigment is roughly classified into a self-dispersible pigment, which is dispersed by itself without using a dispersant, and a resin-dispersed pigment, which is dispersed with a dispersant, depending on the dispersion form. The resin-dispersed pigment is a pigment dispersed in a solvent by adsorption, adhesion, coating, or the like of a dispersant on the pigment surface. As the resin of the dispersant, typically, a water-insoluble resin, a water-soluble resin, or the like is used. The pigment in the present embodiment uses a crosslinked resin as the dispersant. Hereinafter, the pigment dispersed with the crosslinked resin is also referred to as “crosslinked resin-dispersed pigment.” When the pigment surface is thus at least partially coated with the crosslinked resin, the dispersant is less likely to be separated from the pigment surface by dissolution, and dispersion destruction is less likely to occur even in the presence of the high log P_{ow} solvent. As a result, the ink is excellent in the dispersion stability of the pigment even under the presence of the high log P_{ow} solvent, and the storage stability and the clogging recoverability improve.

The method for producing the crosslinked resin-dispersed pigment is not particularly limited, and examples thereof include a method including a step of polymerizing a resin having a reactive functional group such as a carboxy group or a hydroxy group, a step of mixing the resin and a pigment, and a step of crosslinking the resin with a crosslinking agent to cover the pigment surface.

The crosslinked resin used as the dispersant is not particularly limited, and may be obtained by, for example, reacting a resin having a reactive functional group such as a carboxy group or a hydroxy group and a crosslinking agent having two or more groups that react with the reactive functional group.

Examples of the monomer constituting the resin having a reactive functional group include a monomer having an ionic group and a hydrophobic monomer, and a monomer other than these may be included. The resin having a reactive functional group may be a copolymer of a monomer having an ionic group and a hydrophobic monomer.

The monomer having an ionic group is not particularly limited, and examples thereof include unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrene sulfonic acid, 2-acrylamido-2-methylpropanesulfonic acid, and 3-sulfopropyl (meth)acrylate; unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate; unsaturated tertiary amine-containing monomers such as N,N-dimethylaminoethyl (meth)acrylate, N,N-dimethylaminopropyl (meth)acrylate, N,N-diethylaminoethyl (meth)acrylate, N,N-dimethylaminopropyl (meth)acrylamide, N,N-dimethylallylamine, vinylpyrrolidone, 2-vinylpyridine, 4-vinylpyridine, 2-methyl-6-vinylpyridine, and 5-ethyl-2-vinylpyridine; and unsaturated ammonium salt-containing monomers such as quaternized N,N-dimethylaminoethyl (meth)acrylate, quaternized N,N-diethylaminoethyl (meth)acrylate, and quaternized N,N-dimethylaminopropyl (meth)acrylate.

Among these, as the monomer having an ionic group, an anionic monomer is preferable, an unsaturated carboxylic acid monomer is preferable, and acrylic acid and methacrylic acid are more preferable.

The content of the monomer having an ionic group is preferably 1 to 80% by mass, 10 to 50% by mass, 20 to 40% by mass, or 25 to 35% by mass with respect to the total amount of the monomers. When the content of the monomer having an ionic group is within the above range, the redispersibility, the clogging recoverability, and the storage stability tend to further improve.

The hydrophobic monomer is not particularly limited, and examples thereof include alkyl (meth)acrylates such as methyl (meth)acrylate, ethyl (meth)acrylate, propyl (meth)acrylate, butyl (meth)acrylate, amyl (meth)acrylate, cyclohexyl (meth)acrylate, 2-ethylhexyl (meth)acrylate, octyl (meth)acrylate, decyl (meth)acrylate, dodecyl (meth)acrylate, stearyl (meth)acrylate, isopropyl (meth)acrylate, isobutyl (meth)acrylate, tert-butyl (meth)acrylate, isoamyl (meth)acrylate, isooctyl (meth)acrylate, isodecyl (meth)acrylate, isododecyl (meth)acrylate, and isostearyl (meth)acrylate; and aromatic group-containing monomers such styrene, α-methylstyrene, 2-methylstyrene, vinyltoluene, divinylbenzene, chlorostyrene, phenyl (meth)acrylate, benzyl (meth)acrylate, and phenoxyethyl (meth)acrylate.

Among these, as the hydrophobic monomer, a styrene-based monomer is preferable, and styrene, α-methylstyrene, and 2-methylstyrene are more preferable.

The content of the hydrophobic monomer is preferably 30 to 99% by mass, 50 to 90% by mass, 60 to 80% by mass, or 65 to 75% by mass with respect to the total amount of the monomers. When the content of the hydrophobic monomer is within the above range, the redispersibility, the clogging recoverability, and the storage stability tend to further improve.

The polymerization initiator used for polymerizing the resin having a reactive functional group is not particularly limited, and examples thereof include 2,2′-azobis(2-amidinopropane) dibasic acid, 4,4′-azobis(4-cyanovaleric acid), 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(2-imidazolin-2-yl)propane] disulfate dihydrate, 2,2′-azobis[2-(3, 4, 5, 6-tetrahydropyrimidin-2-yl)propane]dihydrochloride, 2,2′-azobis[2-(1-(2-hydroxyethyl)-2-yl)propane]dihydrochloride, 2,2′-azobis(2-methylpropionamidine) dihydrochloride, and 2,2′-azobis[N-(2-carboxyethyl)-2-methylpropionamide]. These can each be used alone, or two or more kinds thereof can be used in combination.

The chain transfer agent used for polymerization of the resin having a reactive functional group is not particularly limited, and examples thereof include polymerization chain transfer agents having an anionic group such as 2-mercaptopropionic acid, 3-mercaptopropionic acid, mercaptosuccinic acid, thioglycolic acid, thiolactic acid, 4,4′-dithiobutyric acid, 3,3′-dithiopropionic acid, and dithioglycolic acid; polymerization chain transfer agents having a cationic group such as 1-amino-2-methyl-2-propanethiol, 2-aminoethanethiol, 2-diethylaminoethanethiol, 2-dimethylaminoethanethiol, 4-aminothiophenol, dithiodianiline, 3, 4, 5, 6-tetrahydro-2-pyrimidinethiol, and 2-mercaptothiazoline; and polymerization chain transfer agents having an amphoteric ionic group such as thiol group-containing amino acids such as DL-penicillamine, N-(2-mercaptopropionyl) glycine, DL-cysteine, DL-homocysteine, cystamine, and DL-cystine, and derivatives thereof.

Examples of the crosslinking agent include ones capable of reacting with the reactive functional group of the resin to form an ester bond, a thioester bond, an amide bond, an amino bond, an ether bond, a thioether bond, a carbonyl bond, a thiocarbonyl bond, a sulfonyl bond, or the like. The number of reactive functional groups of the crosslinking agent is preferably two or more or three or more. By using the resin crosslinked by such a compound, the storage stability and the clogging recoverability of the ink jet ink composition tend to further improve.

Such a crosslinking agent is not particularly limited, and a compound having two or more of any of an epoxy group, an oxazoline group, and an isocyanate group in the molecule is more preferable. By using the resin crosslinked by such a compound, the storage stability and the clogging recoverability of the ink jet ink composition tend to further improve.

Among these, the polyfunctional epoxy compound is not particularly limited, and examples thereof include polypropylene glycol diglycidyl ether, glycerol polyglycidyl ether, polyglycerol polyglycidyl ether, trimethylolpropane polyglycidyl ether, sorbitol polyglycidyl ether, pentaerythritol polyglycidyl ether, resorcinol diglycidyl ether, neopentyl glycol diglycidyl ether, and hydrogenated bisphenol A type diglycidyl ether.

The addition amount of the crosslinking agent is preferably 20 to 80 mol %, 25 to 60 mol %, 30 to 50 mol %, or 35 to 45 mol % with respect to the total amount of the reactive functional group of the resin. When the addition amount of the crosslinking agent is within the above range, the redispersibility, the clogging recoverability, and the storage stability tend to further improve.

The pigment used in the crosslinked resin-dispersed pigment is not particularly limited, and examples thereof include C.I. Pigment Yellow 12, 13, 14, 17, 20, 24, 74, 83, 86, 93, 94, 95, 97, 109, 110, 117, 120, 125, 128, 129, 137, 138, 139, 147, 148, 150, 151, 153, 154, 155, 166, 168, 175, 180, 181, 185, and 191; C.I. Pigment Orange 16, 36, 43, 51, 55, 59, 61, 64, 71, and 73; C.I. Pigment Red 4, 5, 9, 23, 48, 49, 52, 53, 57, 97, 112, 122, 123, 144, 146, 147, 149, 150, 166, 168, 170, 176, 177, 180, 184, 185, 192, 202, 207, 214, 215, 216, 217, 220, 221, 223, 224, 226, 227, 228, 238, 240, 242, 254, 255, 264, 269, and 272; C.I. Pigment Violet 19, 23, 29, 30, 37, 40, and 50; C.I. Pigment Blue 15, 15:1, 15:3, 15:4, 15:6, 22, 60, and 64; C.I. Pigment Green 7 and 36; C.I. Pigment Black 7; and C.I. Pigment White 6.

The content of the crosslinked resin-dispersed pigment is preferably 1 to 10% mass, 3 to 8% by mass, or 4 to 6% by mass with respect to the total amount of the ink jet ink composition. When the content of the crosslinked resin-dispersed pigment is within the above range, the redispersibility, the clogging recoverability, and the storage stability tend to further improve.

### 1.2. Resin Binder

Typical examples of the resin binder include a self-emulsifying type resin binder, which is stabilized as a resin emulsion by itself without using an emulsifier, and an emulsifier type resin binder, which is stabilized as a resin emulsion by using an emulsifier, depending on the dispersion form.

The self-emulsifying type resin binder has a high water concentration in the ink and is self-emulsified. However, the self-emulsifying type resin binder is dissolved when the concentration of the high log P_{ow} solvent is increased due to evaporation of water in a nozzle or the like. Then, when the concentration of water is increased again by the supply of new ink, the ink is self-emulsified again and dispersed again. As described above, the self-emulsifying type resin binder contributes to further improvement in the abrasion resistance of the obtained recorded matter, and since the dissolution and the dispersion are reversible, the self-emulsifying type resin binder does not become a foreign substance or cause clogging even when the ink is dried, and is excellent in the redispersibility and the clogging recoverability.

The monomer constituting the self-emulsifying type resin binder is not particularly limited, and a hydrophobic monomer or a hydrophilic monomer can be used. The hydrophobic monomer is not particularly limited, and examples thereof include alkyl (meth)acrylates such as methyl (meth)acrylate, ethyl (meth)acrylate, propyl (meth)acrylate, butyl (meth)acrylate, amyl (meth)acrylate, cyclohexyl (meth)acrylate, 2-ethylhexyl (meth)acrylate, octyl (meth)acrylate, decyl (meth)acrylate, dodecyl (meth)acrylate, stearyl (meth)acrylate, isopropyl (meth)acrylate, isobutyl (meth)acrylate, tert-butyl (meth)acrylate, isoamyl (meth)acrylate, isooctyl (meth)acrylate, isodecyl (meth)acrylate, isododecyl (meth)acrylate, isostearyl (meth)acrylate, and dicyclopentanyl (meth)acrylate; and aromatic group-containing monomers such as styrene, α-methylstyrene, 2-methylstyrene, vinyltoluene, divinylbenzene, chlorostyrene, phenyl (meth)acrylate, benzyl (meth)acrylate, and phenoxyethyl (meth)acrylate.

Examples of the hydrophilic monomer include unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrenesulfonic acid, 2-acrylamido-2-methylpropanesulfonic acid, and 3-sulfopropyl (meth)acrylate; unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate; unsaturated tertiary amine-containing monomers such as N,N-dimethylaminoethyl (meth)acrylate, N,N-dimethylaminopropyl (meth)acrylate, N,N-diethylaminoethyl (meth)acrylate, N,N-dimethylaminopropyl (meth)acrylamide, N,N-dimethylallylamine, vinylpyrrolidone, 2-vinylpyridine, 4-vinylpyridine, 2-methyl-6-vinylpyridine, and 5-ethyl-2-vinylpyridine; and ionic monomers such as unsaturated ammonium salt-containing monomers such as quaternized N,N-dimethylaminoethyl (meth)acrylate, quaternized N,N-diethylaminoethyl (meth)acrylate, and quaternized N,N-dimethylaminopropyl (meth)acrylate.

The self-emulsifying type resin binder may be a copolymer of a hydrophilic monomer, a hydrophobic monomer, and the like. The copolymer may be a random polymer or a block polymer. In addition, the block polymer may be a diblock polymer, a triblock polymer, or may have more blocks. Further, the block may include a single monomer, or include two or more kinds of monomers. In the block including two or more kinds of monomers, the two or more kinds of monomers may be randomly arranged.

Among these, the self-emulsifying type resin binder preferably includes a block polymer including an A block and a B block having a higher acid value than the A block. Examples of such an AB block polymer include a polymer having the A block with high hydrophobicity and the B block with high hydrophilicity. According to this, the self-emulsifying type resin binder is likely to have a micelle structure, in which a hydrophobic block is oriented toward the center and a hydrophilic block is oriented toward the outside, the solubility in water further improves, and the redispersibility, the clogging recoverability, and the storage stability tend to further improve. In addition, since the solubility in the high log P_{ow} solvent is excellent because of having a hydrophobic moiety, the clogging recoverability and the redispersibility tend to further improve.

Note that the acid value in the present embodiment can be determined by calculation from the proportion of a monomer having an acidic group among the monomers in the block.

The monomer constituting the B block may include a monomer having no acidic group, as needed, in addition to the monomer having an acidic group. Further, the monomer constituting the A block may include the monomer having an acidic group within a range not exceeding the acid value of the B block, in addition to the monomer having no acidic group.

Examples of the monomer having an acidic group include, among the hydrophilic monomers described above, unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrene sulfonic acid, 2-acrylamido-2-methylpropanesulfonic acid, and 3-sulfopropyl (meth)acrylate; and unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate.

The monomer having no acidic group is not particularly limited, and examples thereof include other monomers such as a hydrophobic monomer.

The content of the monomer having an acidic group in the B block is preferably 1 to 50% by mass, 5 to 40% by mass, 10 to 30% by mass, or 15 to 25% by mass with respect to the total amount of the monomers of the B block. When the content of the monomer having an acidic group in the B block is within the above range, the abrasion resistance, the clogging recoverability, and the redispersibility tend to further improve.

In the present embodiment, the block polymer including the A block and the B block having a higher acid value than the A block is preferably a block polymer having two kinds of hydrophobic monomers or a block polymer having one kind of each of a hydrophobic monomer and a hydrophilic monomer. The hydrophobic monomers included in the A block and the B block may be the same.

The method for obtaining such a polymer is not particularly limited, and examples thereof include free radical polymerization and living radical polymerization. Among these, the living radical polymerization is preferably used in order to obtain a precise polymer structure. The living radical polymerization is not particularly limited, and examples thereof include the NMP method, which uses nitroxide, the ATRP method, which uses the oxidation-reduction of a metal complex, the RAFT method, which uses a dithiocarboxylic acid ester or the like, a method using a cobalt catalyst, the TERP method, which uses a tellurium compound, iodine transfer polymerization, which uses iodine, and the RTCP method, which uses an iodide as an initiator and an organic compound as a catalyst.

The initiator is not particularly limited so long as it is a known initiator used for radical polymerization, and examples thereof include azo compounds such as azobis(isobutyronitrile) and 2,2′-azobis(4-methoxy 2,4-dimethylvaleronitrile); and peroxides such as benzoyl peroxide and dicumyl peroxide.

The self-emulsifying type resin binder is preferably solution polymerized in an organic solvent having an octanol-water partition coefficient log P_{ow} value of 0 to 1. By using such a self-emulsifying type resin binder, the redispersibility and the clogging recoverability tend to further improve. Note that the organic solvent having a log P_{ow} value of 0 to 1 used here may be the same as or different from the organic solvent A having a log P_{ow} value of 0 to 1 contained in the ink.

The content of the self-emulsifying type resin binder is preferably 0.1 to 7% by mass, 0.5 to 5% by mass, or 1.5 to 3% by mass with respect to the total amount of the ink jet ink composition. When the content of the self-emulsifying type resin binder is within the above range, the abrasion resistance and the clogging recoverability tend to further improve.

### 1.3. Organic Solvent

The ink composition of the present embodiment contains an organic solvent A having an octanol-water partition coefficient log P_{ow} value of 0 to 1, and as needed, may contain an organic solvent B having a log P_{ow} value other than 0 to 1.

The log P_{ow} value of the organic solvent A is preferably 0.1 to 1, 0.2 to 0.9, 0.3 to 0.8, 0.4 to 0.7, or 0.5 to 0.6. When the log P_{ow} value of the organic solvent A is within the above range, the clogging recoverability is excellent. The organic solvent A tends to have high solubility of the resin when the log P_{ow} value is 0 or more and be excellent in the compatibility with water when the log P_{ow} value is 1 or less. Therefore, the redispersibility and the clogging recoverability improve.

In the present embodiment, the octanol-water partition coefficient log P_{ow} value refers to a value defined by OECD Test Guideline 107. A higher log P_{ow} value indicates higher hydrophobicity, and a lower log P_{ow} value indicates higher hydrophilicity.

The log P_{ow} value of a compound can be determined by various methods, and for example, it can be determined by measurement according to the measurement method specified in JIS Z 7260-117. It can also be calculated using Hansen Solubility Parameter Software (HSPIP).

The organic solvents A and B are not particularly limited, and examples thereof include monoalcohols, glycols, ketones, ethers, trihydric alcohols, and a lactam compound.

Examples of ethers include dimethyl ether, methyl ethyl ether, diethyl ether, isopropyl methyl ether, isopropyl ethyl ether, and glycol ethers.

Glycol ethers may be monoethers or diethers of alkylene glycols, and examples thereof include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of monoalcohols include methanol, ethanol, n-propyl alcohol, isopropyl alcohol, n-butanol, 2-butanol, tert-butanol, isobutanol, n-pentanol, 2-pentanol, 3-pentanol, tert-pentanol, 2-phenoxyethanol, benzyl alcohol, and phenoxypropanol.

Examples of glycols include alkanediols and a condensate having a structure in which hydroxy groups between molecules of alkanediols are condensed. They are also called alkylene glycols.

Alkanediols are alkanes substituted with two hydroxy groups. Alkanediols of alkanes having 2 to 10 carbon atoms are preferable. Furthermore, alkanediols of alkanes having 5 to 9 carbon atoms are preferable, and alkanediols of alkanes having 6 to 8 carbon atoms are more preferable. On the other hand, alkanediols of alkanes having 2 to 4 carbon atoms are also preferable. Further, 1,2-alkanediols are preferable.

The condensate having a structure in which hydroxy groups between molecules of alkanediols are condensed is preferably a condensate having a structure in which hydroxy groups between molecules of diols of alkanes having 2 to 4 carbon atoms are condensed.

Examples of glycols include alkanediols such as ethylene glycol, propylene glycol, 1,2-propanediol, 1,2-butanediol, 1,2-pentanediol, 1,2-hexanediol, 1,2-octanediol and the like, 1,3-propanediol, 1,4-butanediol, and 1,6-hexanediol; and glycols such as tetramethylene glycol, hexamethylene glycol, ethylene glycol, diethylene glycol, triethylene glycol, tetraethylene glycol, polyethylene glycol, propylene glycol, dipropylene glycol, tripropylene glycol, polypropylene glycol, and (poly)tetramethylene glycol.

Examples of ketones include acetone, methyl ethyl ketone, and diethyl ketone.

Examples of trihydric alcohols include glycerin and trimethylolpropane.

Examples of the lactam compound include 2-pyrrolidone, N-methyl-2-pyrrolidone, N-ethyl-2-pyrrolidone, and N-hydroxyethylpyrrolidone (HEP).

Among the above organic solvents, the organic solvent A has an octanol-water partition coefficient log P_{ow} value of 0 to 1.

Among these, the organic solvent A is preferably any one of alkanediols, monoalcohols, ketones, and ethers, and more preferably any one of glycol ethers and alkanediols. When such an organic solvent is contained, the storage stability and the clogging recoverability tend to further improve.

Examples of such an organic solvent A include isopropyl methyl ether, diethylene glycol monobutyl ether, 1,2-hexanediol methyl ethyl ketone, isopropyl alcohol, and methyl ethyl ketone.

The content of the organic solvent A is preferably 0.5 to 15% by mass, 3 to 11% by mass, 5 to 9% by mass, or 6 to 8% by mass with respect to the total amount of the entire ink. When the content of the organic solvent A is within the above range, the redispersibility and the clogging recoverability tend to further improve.

The content of the organic solvent B is preferably 0 to 24% by mass, 5 to 22% by mass, 10 to 20% by mass, or 15 to 19% by mass with respect to the total amount of the entire ink. When the content of the organic solvent B is within the above range, the ejection stability tends to improve, and the compatibility of the organic solvent A tends to further improve.

The total content of the organic solvent including the organic solvents A and B is preferably 0.5 to 30% by mass, 5 to 29% by mass, 10 to 28% by mass, 15 to 27% by mass, or 20 to 26% by mass with respect to the total amount of the entire ink. When the content of the organic solvent is within the above range, the ejection stability tends to improve, and the compatibility of the organic solvent A tends to further improve.

### 1.4. Surfactant

The ink composition in the present embodiment may contain a surfactant. Examples of the surfactant include a silicone-based surfactant, an acetylene glycol-based surfactant, and a fluorine-based surfactant. One kind of the surfactant may be used alone, or two or more kinds thereof may be used in combination.

Among these, the acetylene glycol-based surfactant is preferable. Commercially available products of the acetylene glycol-based surfactant are not particularly limited, and examples thereof include Olfine E1010 and EXP4200, Surfynol SE, Surfynol 440, and Surfynol 104 (manufactured by Nissin Chemical Co., Ltd.). Commercially available products of the silicone-based surfactant are not particularly limited, and examples thereof include KF-640 and KF-6013 (manufactured by Shin-Etsu Chemical Co., Ltd.).

The ink composition in the present embodiment preferably contains an acetylene glycol-based surfactant having an HLB value of 5 or less. When the acetylene glycol-based surfactant having an HLB value of 5 or less is contained, the permeability of the ink into a recording medium further improves. In addition, since it is possible to increase the wettability of the ink with respect to members in an ink supply system and remove air bubbles, the clogging recoverability tends to further improve. Meanwhile, the acetylene glycol-based surfactant having an HLB value of 5 or less generally has low solubility in water and is easily phase-separated, but in the present embodiment, by using the high log P_{ow} solvent, the solubility of the acetylene glycol-based surfactant can be increased to inhibit the phase separation.

In the present embodiment, the HLB (hydrophile-lipophile balance) value is a value proposed by Davies et al. for evaluating the hydrophilicity of a compound, is a numerical value obtained by the Davies method defined in the literature “J. T. Davies and E. K. Rideal, “Interface Phenomena,” 2nd ed., Academic Press, New York 1963,” and indicates a value calculated by the following expression. The HLB value is a value for evaluating the hydrophilicity of a compound, and there is a tendency that the larger the HLB value, the higher the hydrophilicity, and the smaller the HLB value, the higher the hydrophobicity.

$$HLB value = 7 + \sum [ 1 ] \sum [ 2 ]$$

(where [1] represents the number of hydrophilic groups, and [2] represents the number of hydrophobic groups.)

Commercially available products of the acetylene glycol-based surfactant having an HLB value of 5 or less are not particularly limited, and examples thereof include Surfynol 104 (manufactured by Nissin Chemical Co., Ltd.).

The content of the acetylene glycol-based surfactant is preferably 0.1 to 3% by mass, 0.5 to 2.5% by mass, or 1.0 to 2.0% by mass with respect to the total amount of the ink composition. When the content of the surfactant is within the above range, the clogging recoverability tends to further improve.

The content of the surfactant is preferably 0.1 to 4.0% by mass, 0.3 to 3.0% by mass, 0.5 to 2.5% by mass, or 1.0 to 2.0% by mass with respect to the total amount of the ink composition. When the content of the surfactant is within the above range, the clogging recoverability tends to further improve.

### 1.5. pH Adjuster

The ink jet ink composition in the present embodiment may contain a pH adjuster, as needed. Examples of the pH adjuster include inorganic acids (e.g., sulfuric acid, hydrochloric acid, nitric acid, and the like), inorganic bases (e.g., lithium hydroxide, sodium hydroxide, potassium hydroxide, ammonia, and the like), organic acids (e.g., adipic acid, citric acid, succinic acid, and the like), and organic bases (triethanolamine, diethanolamine, monoethanolamine, triisopropanolamine, diisopropanolamine, and trishydroxymethylaminomethane). One kind of the pH adjuster may be used alone, or two or more kinds thereof may be used in combination.

### 1.6. Water

The ink jet ink composition of the present embodiment is an aqueous ink containing water. The aqueous ink jet ink composition is an ink jet ink composition containing at least water as a main solvent component of the ink.

The content of water is preferably 40 to 99% by mass, 50 to 98% by mass, 60 to 95% by mass, 63 to 85% by mass, 64 to 75% by mass, 65 to 70% by mass, or 66 to 68% by mass with respect to the total amount of the ink jet ink composition. When the content of water is within the above range, the storage stability tends to further improve.

### 1.7. Other Components

The ink composition may contain components other than the components described above. As the other components, various additives such as a dissolution aid, a viscosity modifier, an antioxidant, a preservative, a fungicide, and a corrosion inhibitor can be added as appropriate.

### 2. Ink Jet Recording Method

An ink jet recording method according to the present embodiment includes a step of, using a predetermined ink jet head, ejecting the ink jet ink composition from an ink jet head to attach the ink jet ink composition to a recording medium.

### 3. Ink jet Recording Apparatus

An ink jet recording apparatus of the present embodiment includes the ink composition described above and an ink jet head having a nozzle ejecting the ink composition described above onto a recording medium, and preferably further includes a supply flow path through which the ink composition described above flows and which is connected to the ink jet head, and a filter unit provided in the supply flow path of the ink jet head.

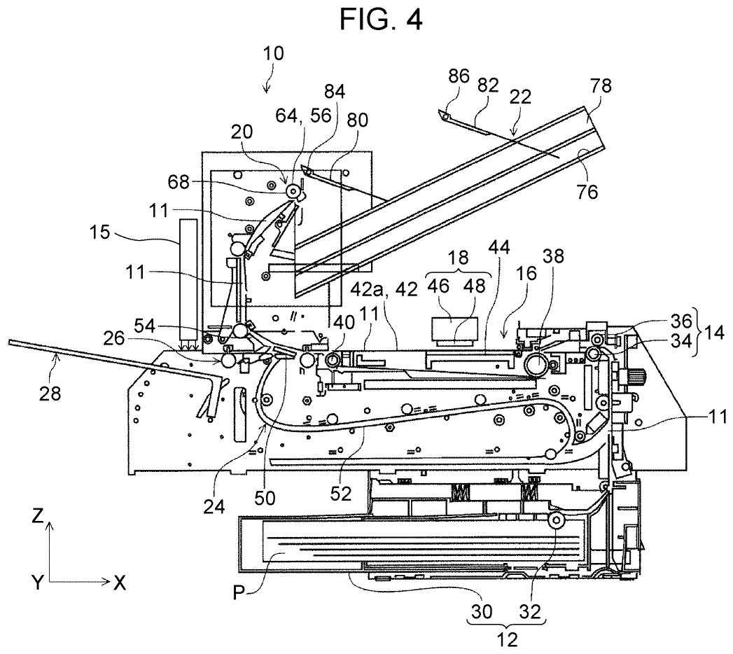

FIG. 4 shows an example of an ink jet recording apparatus that can be used in the present embodiment. The ink jet recording apparatus according to the present embodiment will be described in more detail with reference to FIG. 4. In the X-Y-Z coordinate system shown in FIG. 4, the X direction indicates the length direction of the recording medium, the Y direction indicates the width direction of the recording medium in a transport path in the recording apparatus, and the Z direction indicates an apparatus height direction.

A recording apparatus 10 is, as an example, a line type ink jet printer capable of performing high-speed and high-density printing. The recording apparatus 10 includes a feeding section 12 storing a recording medium P such as paper, a transport section 14, a belt transport section 16, a recording section 8, a face-down (Fd) discharge section 20 as “discharge section,” a face-down (Fd) mounting section 22 as “mounting section,” a reversing path section 24 as “reversing transport mechanism,” a face-up (Fu) discharge section 26, and a face-up (Fu) mounting section 28.

The feeding section 12 is disposed at the lower portion of the apparatus in the recording apparatus 10. The feeding section 12 includes a feeding tray 30 storing the recording medium P and a feeding roller 32 feeding the recording medium P stored in the feeding tray 30 to a transport path 11.

The recording medium P stored in the feeding tray 30 is fed to the transport section 14 along the transport path 11 by the feeding roller 32. The transport section 14 includes a transport driving roller 34 and a transport driven roller 36. The transport driving roller 34 is rotationally driven by a drive source (not shown). In the transport section 14, the recording medium P is nipped between the transport driving roller 34 and the transport driven roller 36 and transported to the belt transport section 16 positioned downstream in the transport path 11.

The belt transport section 16 includes a first roller 38 positioned upstream in the transport path 11, a second roller 40 positioned downstream, an endless belt 42 mounted on the first roller 38 and the second roller 40 in a rotationally movable manner, and a support 44 supporting an upper section 42a of the endless belt 42 between the first roller 38 and the second roller 40.

The endless belt 42 is driven to move from the +X direction to the −X direction in the upper section 42a by the first roller 38 or the second roller 40 driven by a drive source (not shown). Therefore, the recording medium P transported from the transport section 14 is further transported downstream in the transport path 11 in the belt transport section 16.

The recording section 8 includes a line type ink jet head 48 and a head holder 46 holding the ink jet head 48. The recording section 8 may be a serial type recording section, in which an ink jet head is provided on a carriage reciprocating in the Y-axis direction. The ink jet head 48 is disposed to face the upper section 42a of the endless belt 42 supported by the support 44. The ink jet head 48 ejects the ink toward the recording medium P in a case where the recording medium P is transported in the upper side section 42a of the endless belt 42, thereby executing recording. The recording medium P is transported by the belt transport section 16 downstream in the transport path 11 while the recording is carried out.

A first branch section 50 is provided downstream in the transport path 11 in the belt transport section 16. The first branch section 50 is configured to be switchable between the transport path 11 for transporting the recording medium P to the Fd discharge section 20 or the Fu discharge section 26, and a reversing path 52 of the reversing path section 24 for reversing the recording surface of the recording medium P and transporting again the recording medium P to the recording section 8. The recording surface of the recording medium P, which is switched to the reversing path 52 by the first branch section 50 and is transported, is reversed in a transport process in the reversing path 52, and the recording medium P is transported again to the recording section 8 such that the surface opposite to the initial recording surface faces the ink jet head 48.

Further, a second branch section 54 is provided downstream of the first branch section 50 along the transport path 11. The second branch section 54 is configured to be capable of switching the transport direction of the recording medium P so as to transport the recording medium P toward the Fd discharge section 20 or transport the recording medium P toward the Fu discharge section 26.

The recording medium P transported toward the Fd discharge section 20 in the second branch section 54 is discharged from the Fd discharge section 20 and mounted on the Fd mounting section 22. At this time, the recording medium P is mounted such that the recording surface thereof faces the Fd mounting section 22. In addition, the recording medium P transported toward the Fu discharge section 26 in the second branch section 54 is discharged from the Fu discharge section 26 and mounted on the Fu mounting section 28. At this time, the recording medium P is mounted such that the recording surface thereof faces the side opposite to the Fu mounting section 28.

### 4. Recording Medium

The recording medium used in the present embodiment is not particularly limited, and examples thereof include an absorbent recording medium, a low-absorbent recording medium, and a non-absorbent recording medium, and the absorbent recording medium is preferable.

Examples of the absorbent recording medium include plain paper such as electrophotographic paper having high ink permeability, and ink jet paper (ink jet dedicated paper including an ink absorbing layer formed of silica particles or alumina particles or an ink absorbing layer formed of a hydrophilic polymer such as polyvinyl alcohol (PVA) or polyvinylpyrrolidone (PVP)).

Examples of the low-absorbent recording medium include art paper, coated paper, and cast paper, which have relatively low ink permeability and are used for general offset printing.

Examples of the non-absorbent recording medium include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates and plastic films produced by evaporation of these various metals, and plates of alloys such as stainless and brass; and recording media in which a film of plastic such as polyvinyl chloride, polyethylene, polypropylene, polyethylene terephthalate (PET), polycarbonate, polystyrene, or polyurethane is bonded (applied) onto a paper substrate.

### 5. Recorded Matter

A recorded matter of the present embodiment is obtained by attaching the ink composition described above to the recording medium. The recorded matter of the present embodiment using the ink composition described above can be recorded with an ink excellent in the redispersibility, the storage stability, the clogging recoverability, and the abrasion resistance.

### EXAMPLES

The present disclosure will be described below more specifically with reference to Examples and Comparative Examples. The present disclosure is not limited by Examples below in any way.

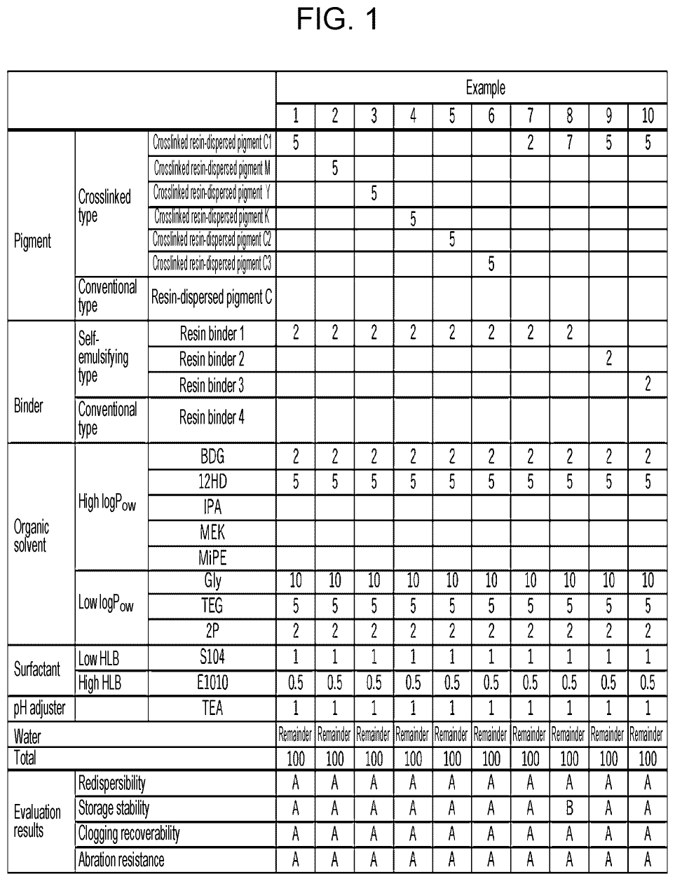

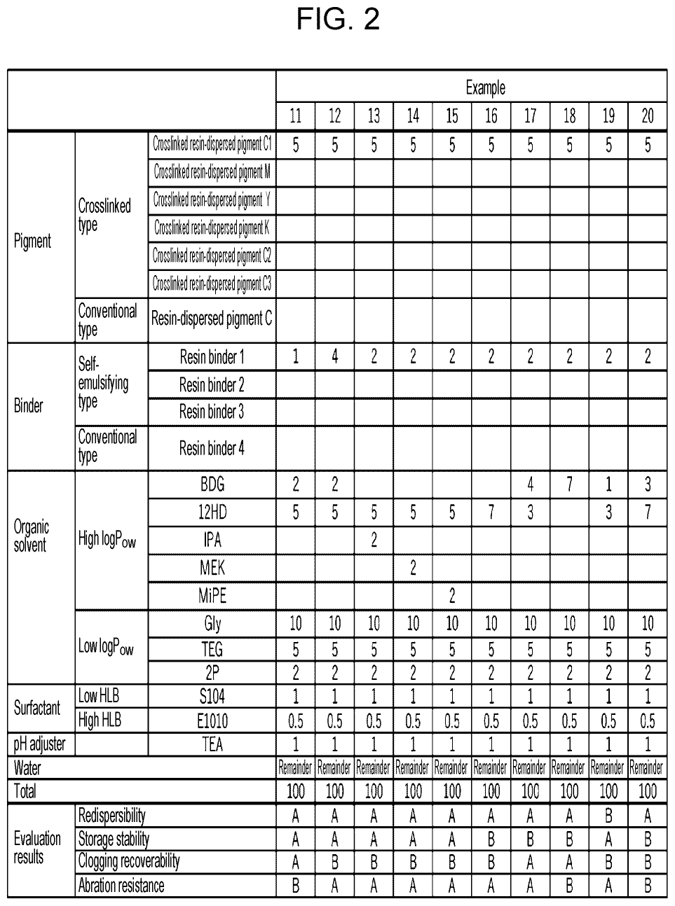

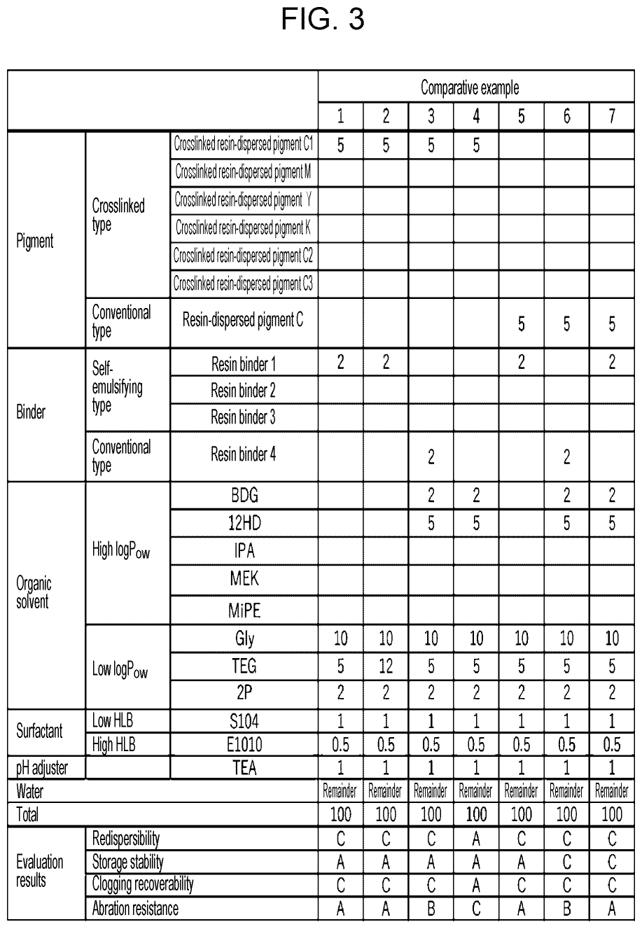

FIG. 1 to FIG. 3 describe Table 1 to 3 showing the compositions of the respective ink compositions of Examples and Comparative Examples and the evaluation results thereof.

### 1. Preparation of Ink Jet Ink Composition

Dispersion liquids are prepared by mixing and stirring so as to have the compositions described in Table 1 to obtain the ink jet ink compositions of the respective examples. It is noted that the numerical value of each component shown in each example in the table represents mass percentage unless otherwise described. In addition, in the table, each numerical value represents the mass percentage of the solid content of the component.

Details of the product components used in Table 1 to Table 3 are as follows:

### Pigment

Crosslinked resin-dispersed pigment (see the following preparation examples)

### Binder

Resin binder (see the following preparation examples)

### Organic Solvent

BDG (diethylene glycol monobutyl ether, log P_{ow} value: 0.56)
12HD (1,2-hexanediol, log P_{ow} value: 0.57)
IPA (isopropyl alcohol, log P_{ow} value: 0.05)
MEK (methyl ethyl ketone, log P_{ow} value: 0.29).
MIPE (isopropyl methyl ether, log P_{ow} value: 1.0)
Gly (glycerin, log P_{ow} value: −1.8)
TEG (triethylene glycol, log P_{ow} value: −1.8)
2P (2-pyrrolidone, log P_{ow} value: −0.9)

### Surfactant

S104 (Surfynol 104, acetylene glycol-based surfactant, HLB value: 4, manufactured by Nissin Chemical Co., Ltd.)
E1010 (acetylene glycol-based surfactant, HLB value: 13 to 14, manufactured by Nissin Chemical Industry, Co., Ltd.) pH Adjuster
TEA (triethanolamine)

### Water

Ion exchanged water

### 1.1. Preparation of Crosslinked Resin-Dispersed Pigment

### Preparation of Crosslinked Resin-Dispersed Pigment C1

### (1) Preparation of Polymer Solution

### Polymer Solution 1

A monomer mixed solution is prepared by mixing 31 parts by mass of acrylic acid and 69 parts by mass of styrene. In a reaction vessel, 5 parts by mass of methyl ethyl ketone, 0.25 part by mass of 3-mercaptopropionic acid (a polymerization chain transfer agent), and 10% by mass of the monomer mixed solution (3.1 parts by mass of acrylic acid and 6.9 parts by mass of styrene) are mixed, and nitrogen gas replacement is sufficiently performed. Next, in a dropping funnel, a mixed solution of the remaining 90% by mass of the monomer mixed solution (28.9 parts by mass of acrylic acid and 62.1 parts by mass of styrene), 2.25 parts by mass of 3-mercaptopropionic acid, 75 parts by mass of methyl ethyl ketone, and 1.5 parts by mass of 4,4′-azobis(4-cyanovaleric acid) (an azo-based radical polymerization initiator, manufactured by FUJIFILM Wako Pure Chemical Corporation) is prepared. Under a nitrogen atmosphere, the inside of the reaction vessel is heated to 77° C. with stirring, and the mixed solution in the dropping funnel is added dropwise over 5 hours. After completion of the dropwise addition, a solution prepared by dissolving 0.5 part by mass of 4,4′-azobis(4-cyanovaleric acid) in 5 parts by mass of methyl ethyl ketone is further added, and the mixture is further reacted at 77° C. for 2 hours to obtain a polymer solution having a carboxy group (solid content concentration: 55% by mass, weight average molecular weight of polymer: 13,900).

### Polymer Solution 2

A polymer solution 2 is obtained by the same procedure as that for the polymer solution 1 except that the monomer mixed solution is obtained by mixing 31 parts by mass of acrylic acid, 57 parts by mass of styrene, and 12 parts by mass of α-methylstyrene.

### (2) Preparation of Pigment Water Dispersion Liquid

### Pigment Water Dispersion Liquid 1

To 24 parts by mass of a polymer obtained by drying the polymer solution 1 obtained above under reduced pressure, 200 parts by mass of ion exchanged water and 9.7 parts by mass of a 5 N aqueous sodium hydroxide solution (sodium hydroxide solid content: 16.9% by mass) are added, and neutralization is performed such that the ratio of the number of moles of sodium hydroxide to the number of moles of carboxy groups of the polymer is 40% (the degree of neutralization: 40 mol %). The aqueous solution is heated at 90° C. for 5 hours with stirring at 150 rpm to obtain a polymer dispersion (the average particle size of polymer particles: 15 nm, solid content concentration: 11% by mass).

To the obtained polymer dispersion, 76 parts by mass of a cyan pigment (PB15:3, manufactured by Dainichiseika Colour & Chemicals Mfg. Co., Ltd.) is added, and the mixture is stirred for 60 minutes under the condition that a disper blade is rotated at 7,000 rpm at 20° C. using a disper (Ultradisper, manufactured by Asada Iron Works Co., Ltd.). The obtained mixture is subjected to dispersion treatment for 10 passes with a microfluidizer (manufactured by Microfluidics Co., Ltd.) at a pressure of 200 MPa. The obtained dispersion liquid is filtered with a 25 mL capacity needleless syringe (manufactured by Terumo Corporation) equipped with a 5 μm filter (acetylcellulose membrane, outer diameter: 2.5 cm, manufactured by Fujifilm Corporation) to remove coarse particles. Ion exchanged water is then added so as to give a solid content concentration of 22% by mass to obtain a pigment water dispersion liquid 1 (the average particle size of pigment-containing polymer particles: 121 nm) (pigment: 76% by mass, polymer: 24% by mass).

### Pigment Water Dispersion Liquid 2

A pigment water dispersion liquid 2 is obtained by the same procedure as that for the pigment water dispersion liquid 1 except that a magenta pigment (PV-19, manufactured by Dainichiseika Colour & Chemicals Mfg. Co., Ltd.) is used as the pigment.

### Pigment Water Dispersion Liquid 3

A pigment water dispersion liquid 3 is obtained by the same procedure as that for the pigment water dispersion liquid 1 except that a yellow pigment (PY-74, manufactured by Dainichiseika Colour & Chemicals Mfg. Co., Ltd.) is used as the pigment.

### Pigment Water Dispersion Liquid 4

A pigment water dispersion liquid 4 is obtained by the same procedure as that for the pigment water dispersion liquid 1 except that a black pigment (PBk-7, manufactured by Dainichiseika Colour & Chemicals Mfg. Co., Ltd.) is used as the pigment.

### Pigment Water Dispersion Liquid 5

A pigment water dispersion liquid 5 is obtained by the same procedure as that for the pigment water dispersion liquid 1 except that the amount of the 5 N aqueous sodium hydroxide solution to be added to the polymer solution is changed to 7.3 parts by mass.

### Pigment Water Dispersion Liquid 6

A pigment water dispersion liquid 6 is obtained by the same procedure as that for the pigment water dispersion liquid 1 except that the polymer solution 2 is used.

### (3) Preparation of Crosslinked Resin-Dispersed Pigment Crosslinked Resin-Dispersed Pigment C1

The pigment water dispersion liquid 1 obtained above in an amount of 100 parts by mass (solid content: 22% by mass) is put into a glass bottle with a screw cap, and 1.27 parts by mass of trimethylolpropane polyglycidyl ether (Denacol EX 321, manufactured by Nagase ChemteX Corporation, molecular weight: 302, epoxy equivalent: 139, water solubility: 27%) as a crosslinking agent having three epoxy groups in one molecule is added such that 40 mol % of all carboxy groups of the polymer are crosslinked, the glass bottle is tightly stopped, and the mixture is heated at 70° C. for 5 hours while being stirred with a stirrer. After a lapse of 5 hours, the temperature is lowered to room temperature, and filtration is performed with a 25 ml capacity needleless syringe (manufactured by Terumo Corporation) equipped with a 5 μm filter (acetylcellulose membrane, outer diameter: 2.5 cm, manufactured by Fujifilm Corporation) to obtain a crosslinked resin-dispersed pigment C1.

### Crosslinked Resin-Dispersed Pigment M

The same procedure as that for the crosslinked resin-dispersed pigment C1 is performed using the pigment water dispersion liquid 2 to obtain a crosslinked resin-dispersed pigment M.

### Crosslinked Resin-Dispersed Pigment K

The same procedure as that for the crosslinked resin-dispersed pigment C1 is performed using the pigment water dispersion liquid 3 to obtain a crosslinked resin-dispersed pigment K.

### Crosslinked Resin-Dispersed Pigment Y

The same procedure as that for the crosslinked resin-dispersed pigment C1 is performed using the pigment water dispersion liquid 4 to obtain a crosslinked resin-dispersed pigment Y.

### Crosslinked Resin-Dispersed Pigment C2

The same procedure as that for the crosslinked resin-dispersed pigment C1 is performed using the pigment water dispersion liquid 5 to obtain a crosslinked resin-dispersed pigment C2.

### Crosslinked Resin-Dispersed Pigments C3

The same procedure as that for the crosslinked resin-dispersed pigment C1 is performed using the pigment water dispersion liquid 6 to obtain a crosslinked resin-dispersed pigment C3.

### 1.2. Preparation of Resin Binder

### Resin Binder 1

Charged into a 1 L separable flask equipped with a stirring blade, a cooling tube, a thermometer, and a nitrogen introducing tube are 350.5 parts by mass of diethylene glycol monobutyl ether (log P_{ow} value: 0.30), 1.0 part by mass of iodine, 3.7 parts by mass of 2,2′-azobis(4-methoxy-2,4-dimethylvaleronitrile), 0.1 part by mass of iodosuccinimide as a catalyst, 52.8 parts by mass of benzyl methacrylate, and 99.4 parts by mass of isobutyl methacrylate, and the mixture is stirred and heated to 45° C.

After 2 hours, after the brown color of iodine disappeared, polymerization is further performed for 3 hours while maintaining the above temperature to obtain a random copolymer A of benzyl methacrylate and isobutyl methacrylate. The random copolymer A has a number average molecular weight of 11,200 and a dispersity of 1.19. Note that the number average molecular weight and the dispersity are measured by GPC using tetrahydrofuran as a developing solvent.

Next, after the solution of the random copolymer A obtained above is cooled to 40° C., 15.1 parts by mass of methacrylic acid and 61.6 parts by mass of benzyl methacrylate are added, and polymerization is further performed at 40° C. for 4 hours to extend a block B in which methacrylic acid and benzyl methacrylate are randomly copolymerized to the terminal of the random copolymer A (a block A), thereby obtaining an AB block polymer. The acid value in the block B is calculated to be 128.4 mgKOH/g. The acid value in the block B is calculated as follows.

First, the amount of methacrylic acid per 1 part by mass of the composition in the block B is determined.

$$15.1 / ( 15.1 + 61.6 ) = 0.197 part by mass$$

Next, using 86.1 as the molecular weight of methacrylic acid and 56.1 as the molecular weight of potassium hydroxide KOH, the acid value in the block B is calculated as follows:

$$( 0.1 \; 97 / 86.1 ) \times 56.1 \times 1 , 000 = 128.4 mg KOH / g$$

It can be confirmed that this AB block polymer solution has a solid content of 50.0% by mass and a polymerization rate of almost 100%. The AB block polymer has a number average molecular weight of 17,500 and a dispersity of 1.33. It can be confirmed that the AB block polymer is formed by confirming that the molecular weight increases more than that of the random copolymer A.

### Resin Binder 2

A resin binder 2 is obtained by the same procedure as that for the resin binder 1 except that the random copolymer A is synthesized using 76.1 parts by mass of dicyclopentanyl methacrylate and 76.1 parts by mass of dodecyl methacrylate instead of the monomer mixture of benzyl methacrylate and isobutyl methacrylate.

### Resin Binder 3

A resin binder 3 is obtained by the same procedure as that for the resin binder 1 except that the random copolymer A is synthesized using 152.2 parts by mass of benzyl methacrylate alone instead of the monomer mixture of benzyl methacrylate and isobutyl methacrylate.

### Resin Binder 4

Into a reaction vessel equipped with a stirrer, a reflux condenser, a dropping device, and a thermometer, 900 g of ion exchanged water and 1 g of sodium lauryl sulfate are charged, and the mixture is heated to 70° C. while being stirred and replaced with nitrogen. While the internal temperature is maintained at 70° C., 4 g of potassium persulfate as a polymerization initiator is added and dissolved, and then an emulsion prepared in advance by adding 20 g of acrylamide, 365 g of styrene, 545 g of butyl acrylate, and 30 g of methacrylic acid to 450 g of ion-exchanged water and 3 g of sodium lauryl sulfate with stirring is continuously added dropwise into the reaction solution over 4 hours. After the dropwise addition, the mixture is aged for 3 hours. The obtained resin emulsion is cooled to normal temperature, and ion exchanged water and an aqueous sodium hydroxide solution are added to give a solid content of 40% by mass and a pH of 8, thus obtaining a resin binder 4.

### 3. Evaluation Methods

### 3.1. Redispersibility

The ink jet ink composition is dropped onto a glass slide and left to stand to be dried at 60° C. for 1 day. Thereafter, the glass slide to which the dried ink adheres is immersed in a sample bottle containing ink water, and the behavior of redispersion of the dried ink is visually observed. Note that this operation is carefully performed so that the ink water is not stirred. Note that the term “ink water” refers to one that contains neither the pigment nor the resin binder in Tables 1 to 3 of Examples. Evaluation criteria for the redispersibility are shown below.

### Evaluation Criteria

A: The dried ink is completely redispersed in the ink water, and neither aggregates nor precipitates are observed.

B: Part of the dried ink is redispersed in the ink water, but aggregates or precipitates are partially observed.

C: The dried ink cannot be redispersed in the ink water, and aggregates or precipitates are observed.

### 3.2. Abrasion Resistance

A printer PX-M791FT (manufactured by Seiko Epson Corporation) is filled with each ink composition, and 26 letters of the alphabet of 20-point size are recorded on Xerox P paper (copy paper manufactured by Fuji Xerox Co., Ltd., basis weight: 64 g/m², paper thickness: 88 μm) as a recording medium. Immediately after the recording, the recording medium is fixed onto a horizontally installed flat surface, and 5 minutes after the recording, the letter portion is rubbed with a line marker “OPTEX CARE” (manufactured by Zebra Co., Ltd.), and then the abrasion resistance is evaluated with the following evaluation criteria based on the degree of bleeding of the ink.

### Evaluation Criteria

A: No color bleeding occurs even when rubbed twice.

B: No color bleeding occurs when rubbed once, but color bleeding occurs when rubbed twice.

C: Color bleeding occurs when rubbed once.

### 3.3. Storage Stability

The ink composition is left to stand in an environment of 60° C. for 1 week. Thereafter, a change rate of the average particle size of the pigment particles in the ink after being left to stand to the average particle size of the pigment particles in the ink before being left to stand is calculated, and evaluated according to the following criteria.

### Evaluation Criteria

A: The change rate is less than +10%.

B: The change rate is +10% or more and less than +20%.

C: The change rate is +20% or more.

3.4. Clogging Recoverability

A printer PX-M791FT (manufactured by Seiko Epson Corporation) is filled with the ink, nozzle checking is performed to check that all the nozzles eject the ink, and then the printer is left to stand at 40° C. for 1 week with the head decapped. After being left to stand, the number of times of cleaning until all the nozzles are recovered is evaluated.

### Evaluation Criteria

A: The number of times of cleaning is 3 or less.

B: The number of times of cleaning is 4 or more and 5 or less.

C: The number of times of cleaning is greater than 5.

Or the nozzles are not fully recovered.

### 4. Evaluation Results

FIGS. 1 to 3 show the compositions of the ink jet inks used in the respective examples and the evaluation results thereof. It is found from FIGS. 1 to 3 that Examples, which are each an ink jet ink composition containing a pigment, a resin binder, and an organic solvent, wherein the pigment includes a resin-dispersed pigment dispersed with a crosslinked resin, the resin binder includes a self-emulsifying type resin binder, the organic solvent includes an organic solvent A having an octanol-water partition coefficient log P_{ow} value of 0 to 1, and the ink jet ink composition is an aqueous ink, are all excellent in the clogging recoverability and the abrasion resistance. Furthermore, the redispersibility and the storage stability are also good.

On the other hand, it is found that Comparative Examples, which are ink jet ink compositions other than that described above, are all inferior in any of the clogging recoverability and the abrasion resistance.

What is claimed is:

1. An ink jet ink composition comprising:
a pigment;
a resin binder; and
an organic solvent, wherein
the pigment includes a resin-dispersed pigment dispersed with a crosslinked resin,
the resin binder includes a self-emulsifying type resin binder,
the organic solvent includes an organic solvent A having an octanol-water partition coefficient log P_{ow} value of 0 to 1, and
the ink jet ink composition is an aqueous ink.

2. The ink jet ink composition according to claim 1, wherein the resin binder includes a block polymer having an A block and a B block having a higher acid value than the A block.

3. The ink jet ink composition according to claim 1, wherein the crosslinked resin is a resin crosslinked by a crosslinking agent having two or more of any of an epoxy group, an oxazoline group, and an isocyanate group in a molecule.

4. The ink jet ink composition according to claim 1, wherein the organic solvent A includes any of alkanediols, monoalcohols, ketones, and ethers.

5. The ink jet ink composition according to claim 1, wherein a content of the organic solvent A is 0.5 to 15% by mass with respect to a total amount of the ink jet ink composition.

6. The ink jet ink composition according to claim 1, wherein the self-emulsifying type resin binder is solution polymerized in an organic solvent having an octanol-water partition coefficient log P_{ow} value of 0 to 1.

7. The ink jet ink composition according to claim 1, further comprising an acetylene glycol-based surfactant having an HLB value of 5 or less.

8. A recording method comprising ejecting the ink jet ink composition according to claim 1 from an ink jet head to attach the ink jet ink composition to a recording medium.
